(19) United States
(12) Patent Application Publication
(10) Pub. No.: US 2012/0125471 A1
(43) Pub. Date: May 24, 2012

(54) Water Pipe Structure

(76) Inventor: Chun-Ping Kuo, Xingang Township (TW)

(21) Appl. No.: 12/948,830

(22) Filed: Nov. 18, 2010

(51) Int. Cl. F16L 9/14

(52) U.S. Cl. 138/140

(57) ABSTRACT

A water pipe structure includes an inner water pipe, and a protective layer mounted on and combined with the inner water pipe to cover an outer periphery of the inner water pipe. The inner water pipe has an outer side provided with at least one extension wing which extends outwardly from the inner water pipe. Thus, the protective layer encompasses the outer periphery of the inner water pipe to protect the inner water pipe.

### BACKGROUND OF THE INVENTION

1. Field of the Invention

The present invention relates to a water carrier and, more particularly, to a water pipe structure.

2. Description of the Related Art

A water pipe is mounted outdoors to deliver water. A conventional water pipe has an inner portion provided with multiple channels and a plurality of ribs between the channels to enhance the strength of the water pipe so as to withstand a larger pressure. However, the conventional water pipe is only available for a special connector, thereby limiting the versatility of the water pipe. In addition, when the water pipe is mounted in the ground of a road, the water pipe is subjected to a pressure the is applied by the passing cars so that the water pipe is easily deflected or displaced due to the pressure and is easily loosened or detached from the connector.

### BRIEF SUMMARY OF THE INVENTION

In accordance with the present invention, there is provided a water pipe structure, comprising an inner water pipe, and a protective layer mounted on and combined with the inner water pipe to cover an outer periphery of the inner water pipe. The inner water pipe has an outer side provided with at least one extension wing which extends outwardly from the inner water pipe.

Preferably, the protective layer is made of a cloth material that is soft and pliable, and the protective layer has two opposite sides each sewn on the respective extension wing of the inner water pipe.

Alternatively, the protective layer is made of a cloth material that is soft and pliable, and the protective layer has two opposite sides each adhered on the respective extension wing of the inner water pipe.

Preferably, the protective layer is bent and folded to encompass and fix the outer periphery of the inner water pipe.

Preferably, the protective layer has different colors or patterns to provide an indication function.

According to the primary advantage of the present invention, the protective layer encompasses the outer periphery of the inner water pipe to protect the inner water pipe so that the protective layer can prevent the inner water pipe from being rubbed or worn by the ground, can prevent the inner water pipe from being distorted or deformed by an external pressure or force, and can prevent the inner water pipe from being penetrated or perforated by a sharp object.

According to another advantage of the present invention, the inner water pipe has an outer side provided with at least one extension wing to enhance the strength of the inner water pipe.

According to a further advantage of the present invention, the inner water pipe can be expanded elastically to have a tubular shape so as to fit and connect a circular fitting or faucet so that the inner water pipe is available for the outdoor road and the indoor house, thereby enhancing the versatility of the water pipe structure.

According to a further advantage of the present invention, the water pipe structure comprises a plurality of fixing members each extending through the respective extension wing of the inner water pipe to attach the water pipe structure to the ground or road exactly and closely, thereby preventing the water pipe structure from being displaced or deflected due to a drawing force.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a water pipe structure in accordance with the preferred embodiment of the present invention.

FIG. 2 is an exploded perspective view of the water pipe structure as shown in FIG. 1.

FIG. 3 is a schematic operational view of the water pipe structure as shown in FIG. 1 in use.

FIG. 4 is a partially perspective view of a water pipe structure in accordance with another preferred embodiment of the present invention.

FIG. 5 is an exploded perspective view of a water pipe structure in accordance with another preferred embodiment of the present invention.

### DETAILED DESCRIPTION OF THE INVENTION

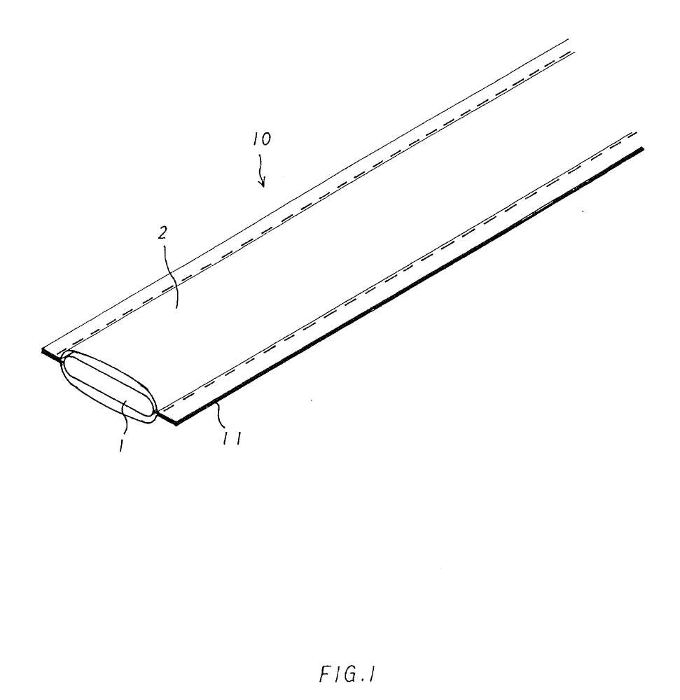

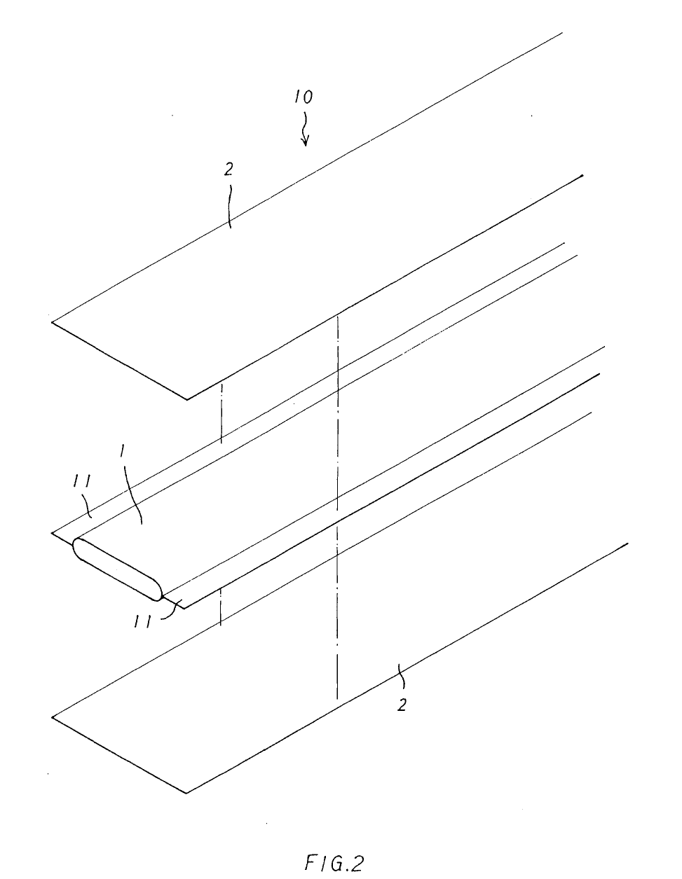

Referring to the drawings and initially to FIGS. 1 and 2, a water pipe structure 10 in accordance with the preferred embodiment of the present invention comprises an inner water pipe 1, and a protective layer 2 mounted on and combined with the inner water pipe 1 to cover an outer periphery of the inner water pipe 1.

The inner water pipe 1 has an outer side provided with at least one extension wing 11 which extends outwardly from the inner water pipe 1. In the preferred embodiment of the present invention, the inner water pipe 1 has two opposite extension wings 11.

The protective layer 2 is made of a cloth material that is soft and pliable. Preferably, the protective layer 2 has different colors or patterns to provide an indication function so that a user can identify the drawing direction of the water pipe structure 10, thereby facilitating maintenance of the water pipe structure 10.

As shown in FIG. 1, the protective layer 2 has two opposite sides each sewn on the respective extension wing 11 of the inner water pipe 1 so that the protective layer 2 can encompass the outer periphery of the inner water pipe 1.

Alternatively, the protective layer 2 has two opposite sides each adhered on the respective extension wing 11 of the inner water pipe 1 so that the protective layer 2 can encompass the outer periphery of the inner water pipe 1.

In practice, the protective layer 2 encompasses the outer periphery of the inner water pipe 1 to protect the inner water pipe 1 so that the protective layer 2 can prevent the inner water pipe 1 from being rubbed or worn by the ground, can prevent the inner water pipe 1 from being distorted or deformed by a pressing or rolling force, and can prevent the inner water pipe 1 from being penetrated or perforated by a sharp object.

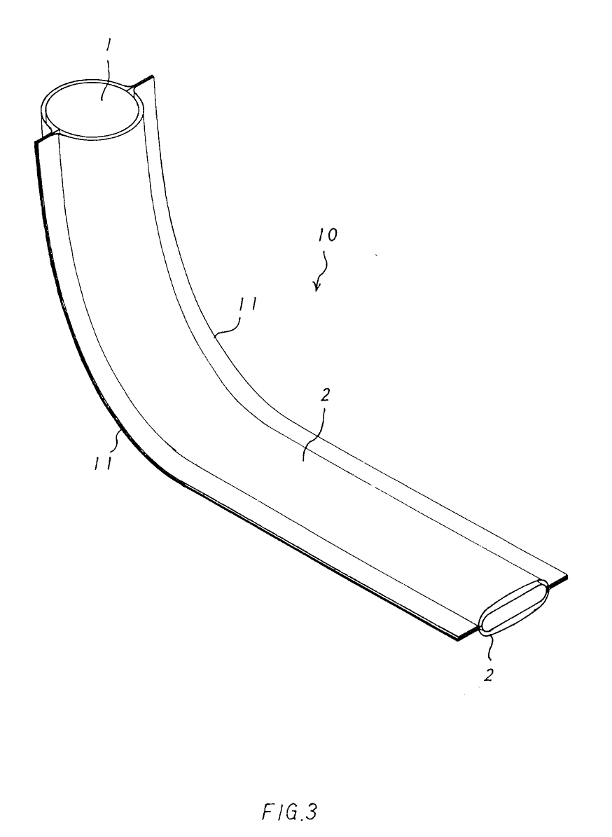

As shown in FIG. 3, the inner water pipe 1 can be expanded elastically to have a tubular shape so as to fit and connect a circular fitting or faucet so that it is unnecessary to use a special connector or hand tool to combine the inner water pipe 1 with the fitting or faucet.

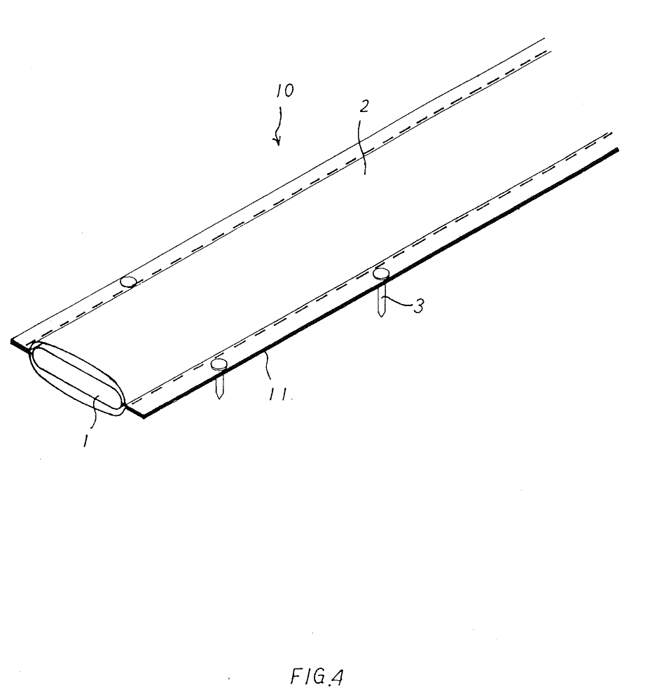

As shown in FIG. 4, the water pipe structure 10 further comprises a plurality of fixing members 3 each extending through the respective extension wing 11 of the inner water pipe 1 to attach the water pipe structure 10 to the ground or road exactly and closely. Preferably, each of the fixing members 3 is a nail or screw.

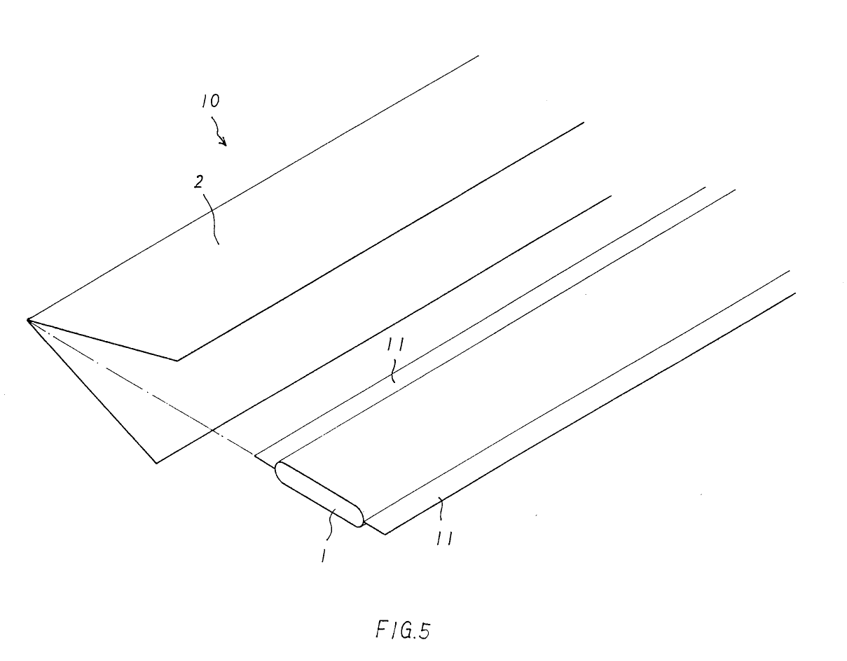

As shown in FIG. 5, the protective layer 2 is bent and folded to encompass and fix the outer periphery of the inner water pipe 1.

Accordingly, the protective layer 2 encompasses the outer periphery of the inner water pipe 1 to protect the inner water pipe 1 so that the protective layer 2 can prevent the inner water pipe 1 from being rubbed or worn by the ground, can prevent the inner water pipe 1 from being distorted or deformed by an external pressure or force, and can prevent the inner water pipe 1 from being penetrated or perforated by a sharp object. In addition, the inner water pipe 1 has an outer side provided with at least one extension wing 11 to enhance the strength of the inner water pipe 1. Further, the inner water pipe 1 can be expanded elastically to have a tubular shape so as to fit and connect a circular fitting or faucet so that the inner water pipe 1 is available for the outdoor road and the indoor house, thereby enhancing the versatility of the water pipe structure 10. Further, the water pipe structure 10 comprises a plurality of fixing members 3 each extending through the respective extension wing 11 of the inner water pipe 1 to attach the water pipe structure 10 to the ground or road exactly and closely, thereby preventing the water pipe structure 10 from being displaced or deflected due to a drawing force.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A water pipe structure, comprising:
an inner water pipe, and a protective layer mounted on and combined with the inner water pipe to cover an outer periphery of the inner water pipe.
The inner water pipe has an outer side provided with at least one extension wing which extends outwardly from the inner water pipe.

2. The water pipe structure of claim 1, wherein
the protective layer is made of a cloth material that is soft and pliable;
the protective layer has two opposite sides each sewn on the respective extension wing of the inner water pipe.

3. The water pipe structure of claim 1, wherein
the protective layer is made of a cloth material that is soft and pliable;
the protective layer has two opposite sides each adhered on the respective extension wing of the inner water pipe.

4. The water pipe structure of claim 1, wherein the protective layer is bent and folded to encompass and fix the outer periphery of the inner water pipe 1.

5. The water pipe structure of claim 1, wherein the protective layer has different colors or patterns to provide an indication function.
